(19) United States
(12) Patent Application Publication
(10) Pub. No.: US 2012/0319936 A1
(43) Pub. Date: Dec. 20, 2012

(54) DISPLAY DEVICE AND DISPLAY METHOD THEREOF

(75) Inventors: Yuhji Tanaka, Osaka-shi (JP); Shigeki Imai, Osaka-shi (JP)

(73) Assignee: SHARP KABUSHIKI KAISHA, Osaka-shi, Osaka (JP)

(21) Appl. No.: 13/582,175

(22) PCT Filed: Jan. 13, 2011
(86) PCT No.: PCT/JP2011/050415

§ 371 Date: Aug. 31, 2012

(30) Foreign Application Priority Data
Apr. 2, 2010 (JP) 2010-085972

(51) Int. Cl. G09G 3/36

(52) U.S. Cl. 345/102

(57) ABSTRACT

Disclosed is a display device capable of changing a video image display area of high significance so as to be brighter than a video image display area of low significance, from among a plurality of video images. The display device comprises a liquid crystal display panel (1), a backlight unit (2), and a video image compositing unit (7) that generates composite video image data and backlight data. The backlight data is generated corresponding to the significance of the plurality of video images, and by the brightness of the backlight being adjusted for each display area on the basis of the backlight data, the video image display area of high significance is made brighter than the video image display area of low significance.

### TECHNICAL FIELD

The present invention is related to a display device and a display method thereof.

### BACKGROUND ART

A liquid crystal display device, which is a type of a display device, incorporates a liquid crystal display panel on which images are displayed. Since the liquid crystal display panel does not emit light itself, the liquid crystal display device is provided with a backlight unit which is disposed on a rear-surface side of the liquid crystal display panel (that is, on a side opposite from the display surface of the liquid crystal display panel) to illuminate the rear-surface side of the liquid crystal display panel, and thereby an image display operation is performed (see, for example, Patent Literature 1).

In the liquid crystal display device of Patent Literature 1, the density of light sources covering a predetermined display area is higher than that of light sources covering other display areas. As a result, the predetermined display area is brighter than the other display areas.

### CITATION LIST

### Patent Literature 1

Patent Literature 1: JP-A-2007-95589

### SUMMARY OF INVENTION

### Technical Problem

An important-image display area displaying an image of high importance is usually made brighter than display areas displaying the other images, but a user may wish to change the important-image display area and specify a different display area as the important-image display area. In such a case, however, with the liquid crystal display device of Patent Literature 1, since a region (a high brightness region) where light sources are densely arranged is fixed, even if the user wishes to change the important-image display area, it is difficult to satisfy the user's desire.

The present invention has been made to solve the above problem, and an object of the present invention is to provide a display device where a change is able to be made such that an area displaying an image of high importance among a plurality of images is brighter than a display area displaying an image of low importance, and another object of the present invention is to provide a display method of such a display device.

### Solution to Problem

To achieve the above object, a display device according to a first aspect of the present invention includes a display panel; a backlight unit which has a light-emitting light source and illuminates the display panel; and an image composing unit which generates composite image data for displaying a composite image composed of a plurality of images each displayed in a desired display area on a display panel and backlight data for adjusting brightness of backlight light outputted from the backlight unit. Here, the backlight data is generated according to importance of each of the plurality of images; and a display area of an image of high importance among the plurality of images is made brighter than a display area of an image of low importance among the plurality of images by adjusting the brightness of the backlight light for each display area on a one-by-one basis based on the backlight data.

According to the first aspect of the present invention, with the above-described configuration, brightness of display areas is changeable such that a display area of an image of high importance among the plurality of images is brighter than a display area of an image of low importance. That is, it is easy to satisfy a user's request to change a display area of an image of high importance (a display area of an image of low importance).

Furthermore, in making a change such that a display area of an image of high importance is brighter than a display area of an image of low importance, by just reducing the brightness of the backlight in the display area of the image of low importance (including a display area where no image is displayed) without changing the brightness of the backlight light in the display area of the image of high importance, power consumption of the backlight unit is able to be reduced corresponding to the reduced brightness of the backlight light in the display area of the image of low importance.

In the display device according to the first aspect of the present invention, an image of the plurality of images a display area of which is largest may be judged to be an image of highest importance. This eliminates the need of separately inputting importance (required brightness) information of a plurality of images. That is, it is possible to control, by just using display-area information of the plurality of images, such that a display area of an image of high importance among the plurality of images is brighter than a display area of an image of low importance among the plurality of images.

In the display device according to the first aspect of the present invention, it is preferable that the light source include a plurality of light sources which are driven independently of one another, and that the brightness of the backlight light be adjusted for each display area on a one-by-one basis by adjusting brightness of light emitted from each of the plurality of light sources individually based on the backlight data. This makes it easy to make a display area of an image of high importance brighter than a display area of an image of low importance and to reduce the power consumption of the backlight unit simultaneously.

In the configuration including the plurality of light sources which are driven independently of one another, a plurality of light emitting diodes may be used as the plurality of light sources, and ratios of on-period to off-period of the plurality of light emitting diodes may be individually controllable. With this configuration, it is possible to minutely adjust the brightness of the backlight light for each display area on a one-by-one basis.

Furthermore, in the configuration including the plurality of light sources which are driven independently of one another, a plurality of light emitting diodes may be used as the plurality of light sources, and values of currents supplied to the plurality of light emitting diodes may be individually controllable. With this configuration, it is easy to adjust the brightness of the backlight light for each display area on a one-by-one basis.

In the display device according to the first aspect of the present invention, it is preferable that light transmittance of each of pixels of the display panel be calculated based on the composite image data and the brightness of the backlight light. With this configuration, it is possible to reduce occurrence of unevenness in brightness.

Furthermore, in calculating the light transmittance of each of the pixels of the display panel, the brightness of the backlight light or the composite image data may be corrected based on a ratio between the brightness of the backlight light in the display area of the image of high importance and the brightness of the backlight light in the display area of the image of low importance.

In the display device according to the first aspect of the present invention, there may be further provided a light guide plate having a side end surface opposite to which the light source is disposed and a top surface from which light introduced into the light guide plate through the side end surface is outputted, the light guide plate being attached to the backlight unit, the light outputted from the top surface of the light guide plate being the backlight light. In this case, it is preferable that brightness of light emitted from part of the light source that is located close to the display area of the image of high importance be higher than brightness of light emitted from part of the light source that is located close to the display area of the image of low importance, to thereby make brightness in a region of the top surface of the light guide plate covering the display area of the image of high importance higher than brightness in a region of the top surface of the light guide plate covering the display area of the image of low importance. With this configuration, in using the backlight unit to which the light guide plate is attached, it is easy to make a display area of an image of high importance brighter than a display area of an image of low importance and to reduce the power consumption of the backlight unit at the same time.

In the display device according to the first aspect of the present invention, the light source may be divided into two or more groups of light sources, and the two or more groups of light sources may be movably held. With this configuration, it is easy to adjust the brightness of the backlight light for each display area on a one-by-one basis by moving the two or more groups of light sources.

According to a second aspect of the present invention, a display method of a display device is a display method of a display device including a display panel, a backlight unit which has a light-emitting light source and illuminates the display panel, and an image composing unit which generates composite image data for displaying a composite image composed of a plurality of images each displayed in a desired display area on a display panel and backlight data for adjusting brightness of backlight light outputted from the backlight unit. The display method includes a step of generating the backlight data according to importance of each of the plurality of images, and a step of making a display area of an image of high importance among the plurality of images brighter than a display area of an image of low importance among the plurality of images by adjusting the brightness of the backlight light for each display area on a one-by-one basis based on the backlight data.

According to the second aspect of the present invention, by using the above display method, it is possible to perform control such that a display area of an image of high importance among a plurality of images is brighter than a display area of an image of low importance and to reduce the power consumption of the backlight light simultaneously.

### Advantageous Effects of Invention

As described hereinabove, according to the present invention, it is easy to perform control such that a display area of an image of high importance among a plurality of images is brighter than a display area of an image of low importance.

### BRIEF DESCRIPTION OF DRAWINGS

FIG. 1 is an exploded perspective view of a liquid crystal display device for illustrating a schematic configuration of the present invention;

FIG. 2 is a block diagram of a liquid crystal display device for illustrating a schematic configuration of the present invention;

FIG. 3 is a diagram schematically showing a composite image displayed on a liquid crystal display panel;

FIG. 4 is a diagram schematically showing composite image data and liquid crystal data;

FIG. 5 is a diagram schematically showing brightness of backlight light;

FIG. 6 is a diagram schematically showing composite image data and liquid crystal data (comparative example);

FIG. 7 is a diagram schematically showing brightness of backlight light (comparative example);

FIG. 8 is an exploded perspective view of a liquid crystal display device according to a modified example of the present invention;

FIG. 9 is an exploded perspective view of a liquid crystal display device according to a modified example of the present invention;

FIG. 10 is a block diagram of a liquid crystal display device according to a first embodiment;

FIG. 11 is a circuit diagram of a driver provided in the liquid crystal display device shown in FIG. 10;

FIG. 12 is a flow chart for illustrating a display method of the first embodiment;

FIG. 13 is a diagram schematically showing backlight data (brightness data);

FIG. 14 is a block diagram of a liquid crystal display device according to a second embodiment;

FIG. 15 is a flow chart for illustrating a display method of the second embodiment;

FIG. 16 is a diagram schematically showing backlight data (current value data);

FIG. 17 is a block diagram of a liquid crystal display device according to a third embodiment;

FIG. 18 is a diagram schematically showing a composite image displayed on a liquid crystal display panel;

FIG. 19 is a diagram schematically showing brightness of backlight light;

FIG. 20 is a diagram for illustrating a correction operation (a comparative example);

FIG. 21 is a diagram for illustrating a correction operation of the third embodiment;

FIG. 22 is a diagram for illustrating a correction operation (a comparative example);

FIG. 23 is a diagram for illustrating a correction operation according to a modified example of the third embodiment;

FIG. 24 is a diagram for illustrating a correction operation according to a modified example of the third embodiment;

FIG. 25 is block diagram of a liquid crystal display device according to a modified example of the present invention;

FIG. 26 is a schematic diagram of a backlight unit incorporated in the liquid crystal display device shown in FIG. 25;

FIG. 27 is a diagram schematically showing a composite image displayed on a liquid crystal display panel;

FIG. 28 is a diagram for illustrating a display operation according to a modified example of the present invention; and

FIG. 29 is a diagram for illustrating a display operation according to a modified example of the present invention.

### DESCRIPTION OF EMBODIMENTS

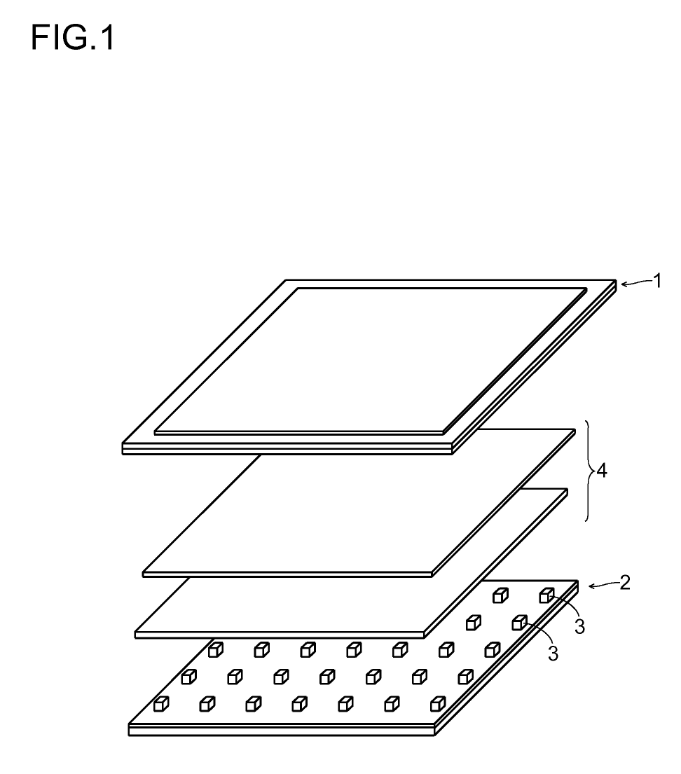

First, before describing specific embodiments of the present invention, a description will be given of a schematic configuration of the present invention with reference to FIGS. 1 to 5.

The present invention is applied to the liquid crystal display device which is a display device, and as shown in FIG. 1, the liquid crystal display device is provided with at least a liquid crystal display panel 1 and a backlight unit 2. The liquid crystal display panel 1 is an example of a “display panel” of the present invention.

The liquid crystal display panel 1 includes a pair of glass substrates (an active matrix substrate and a counter substrate) between which liquid crystal is held, and the liquid crystal display panel 1 has a plurality of pixels in its display region. The backlight unit 2, which has a plurality of light-emitting light sources 3, is disposed on a side of a rear surface (a surface opposite from a display surface) of the liquid crystal display panel 1. In a state in which the backlight unit 2 is disposed on the side of the rear surface of the liquid crystal display panel 1, the plurality of light sources 3 are arranged in a region directly under the liquid crystal display panel 1. Such a backlight unit 2 is called a direct backlight unit. Furthermore, various kinds of optical members (such as a diffusion sheet and a diffusion plate) 4 are disposed between the liquid crystal display panel 1 and the backlight unit 2.

In this liquid crystal display device, an optical property (light transmittance) of the liquid crystal display panel 1 is changed for each pixel on a one-by-one basis, and also, backlight light from the backlight unit 2 illuminates the rear surface side of the liquid crystal display panel 1, whereby an image is displayed on the display surface of the liquid crystal display panel 1.

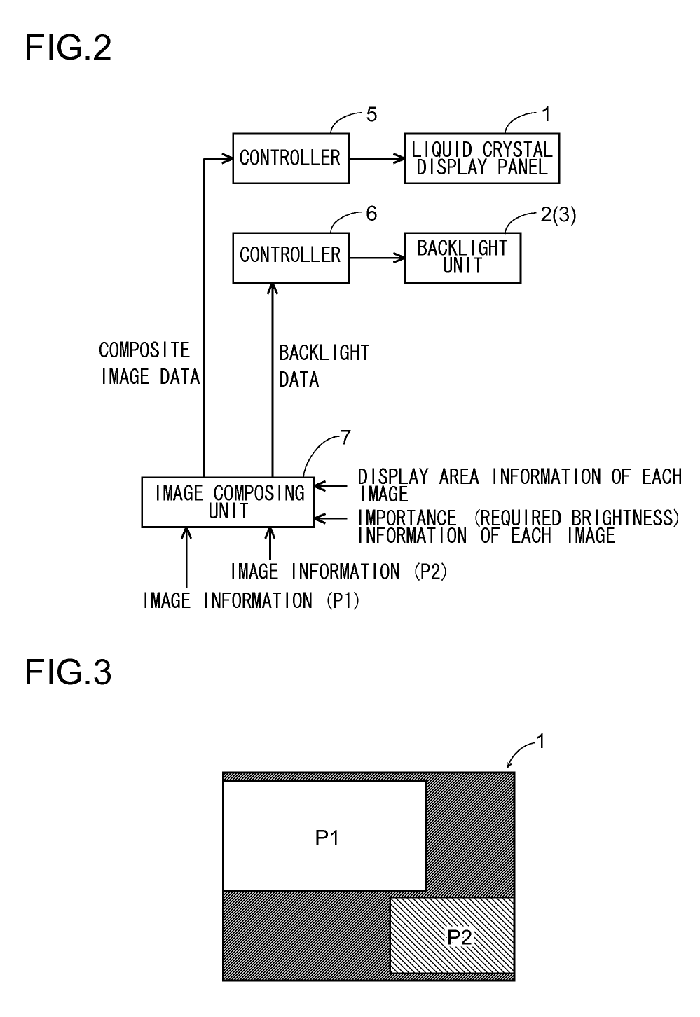

Furthermore, as shown in FIG. 2, a controller 5 is connected to the liquid crystal display panel 1, and by the controller 5, the plurality of pixels are each driven independently of one another.

Moreover, a controller 6 is connected to the backlight unit 2, and by the controller 6, the plurality of light sources 3 are driven independently of one another. In other words, brightness of light emitted from each of the plurality of light sources 3 is adjusted individually. With this configuration, it is possible to partially change the brightness of the backlight light, and thus, it is possible to illuminate a predetermined display area in the liquid crystal display panel 1 with backlight light having brightness that is different from brightness of backlight light illuminating the other display areas (that is, to adjust the brightness of the backlight light for each display area on a one-by-one basis).

The controllers 5 and 6 are connected to an image composing unit 7 to which image information on which images P1 and P2 are to be based, display area information of images P1 and P2, and importance information (required brightness information) of images P1 and P2 is inputted. In the image composing unit 7, based on the various kinds of information inputted to the image composing unit 7, composite image data and backlight data is generated to be supplied to the controllers 5 and 6, respectively.

Here, the composite image data is data based on which the controller 5 controls driving of the liquid crystal display panel 1. That is, light transmittance of each pixel of the liquid crystal display panel 1 is adjusted based on the composite image data, whereby images P1 and P2 are displayed in combination such that image P1 is displayed in a predetermined area while image P2 is displayed in another display area.

The backlight data is data based on which the controller 6 controls the driving of the backlight unit 2, and the backlight data corresponds to the importance (the required brightness) of images P1 and P2. According to the present invention, the brightness of the backlight light is adjusted based on the backlight data for each display area on a one-by-one basis. Specifically, the brightness of the backlight light is made higher in the display area where one of images P1 and P2 that is of higher importance (higher required brightness) is displayed than in the display area where the other one of images P1 and P2 that is of lower importance (lower required brightness) is displayed, and as a result, the display area where the image of higher importance (higher required brightness) is displayed is brighter than the display area where the image of lower importance (lower required brightness) is displayed.

Next, a description will be given of a display operation performed by a liquid crystal display device to which the present invention is applied, dealing with a case where a composite image (images P1 and P2) as shown in FIG. 3 are displayed on the display surface of the liquid crystal display panel 1. In the following description, it is assumed that the importance (the required brightness) of image P1 is higher than that of image P2. That is, the display area in the liquid crystal display panel 1 where image P1 is displayed is made brighter than the display area where image P2 is displayed.

In the display operation of the liquid crystal display device to which the present invention is applied, first, image information on which images P1 and P2 are to be based, display area information of images P1 and P2, and importance (required brightness) information of images P1 and P2 is inputted to the image composing unit 7. Then subsequently, based on the various kinds of information inputted to the image composing unit 7, composite image data and backlight data is generated in the image composing unit 7.

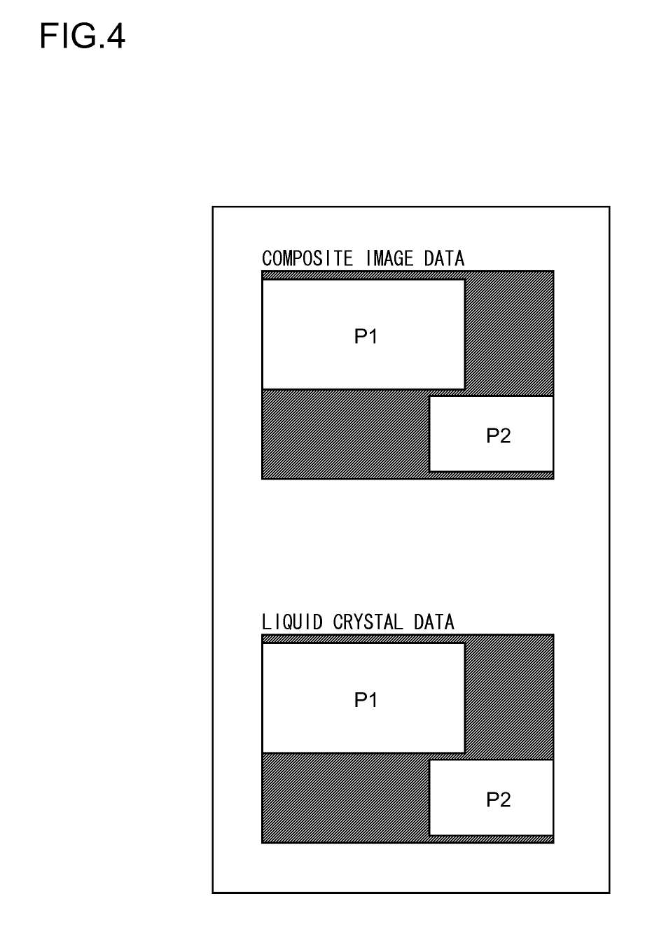

Here, in the thus generated composite image data, as shown in FIG. 4, images P1 and P2 are displayed in respective desired areas, and there is no difference between the overall brightness (tone) of image P1 and that of image P2. Naturally, in the composite image data, a region that corresponds to image P1 includes brightness difference (tone difference), and so does a region that corresponds to image P2. The composite image data is converted to liquid crystal data (light transmittance of each pixel) that directly reflects the tone set in the composite image data.

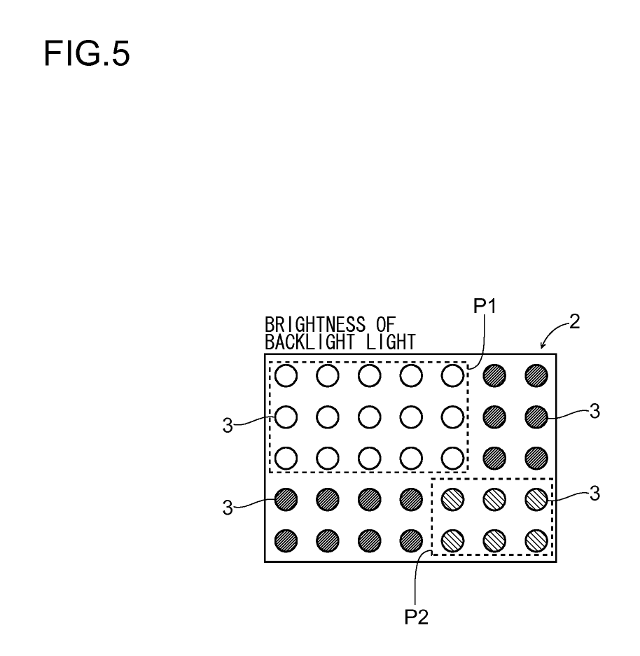

Also, the backlight data is set such that the brightness of the backlight light is higher in the display area of image P1 than in the display area of image P2. Thus, when the driving of the backlight unit 2 is controlled based on the backlight data, as shown in FIG. 5, among the light sources 3, light sources 3 that cover the display area of image P1 are made to emit light of maximum brightness and light sources 3 that cover the display area of image P2 are made to emit light of brightness that is lower than the maximum brightness. Furthermore, among the light sources 3, light sources 3 that cover display areas other than the display areas of images P1 and P2 are made to emit light of minimum brightness. That is, the brightness of the backlight light is adjusted for each display area on a one-by-one basis based on the importance (the required brightness) of images P1 and P2.

Thus, when the rear surface side of the liquid crystal display panel 1 is illuminated by the backlight light emitted from the backlight unit 2, in a composite image (images P1 and P2) displayed on the display surface of the liquid crystal display panel 1, the display area of image P1 of high importance (high required brightness) is made brighter than the display area of image P2 of low importance (low required brightness).

The following method may also be used to display a composite image as shown in FIG. 3 on the display surface of the liquid crystal display panel 1.

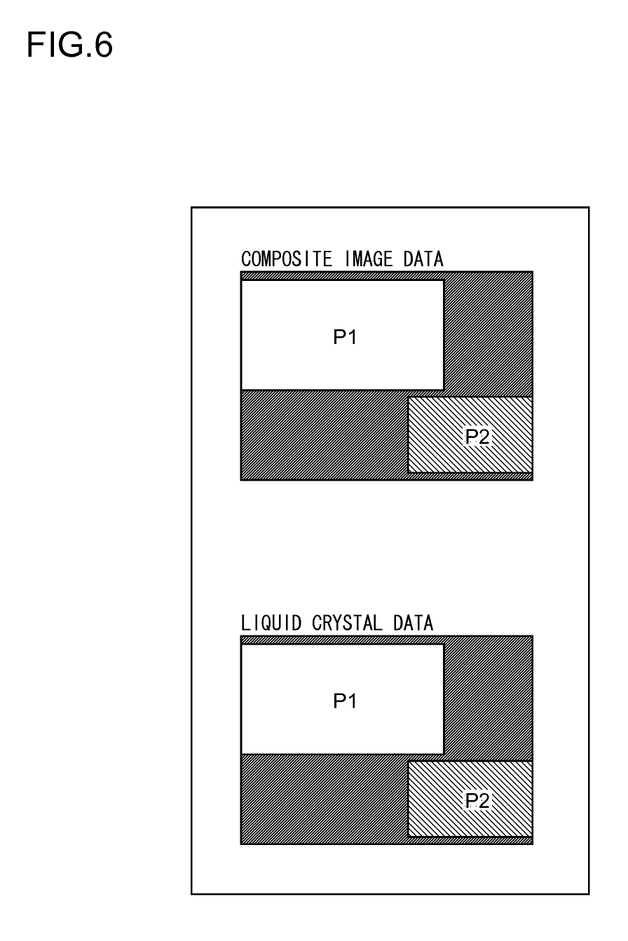

That is, in generating composite image data, as shown in FIG. 6, images P1 and P2 are set in advance to have different overall brightness (tone) such that image P1 is brighter than image P2. Then subsequently, liquid crystal data that directly reflects the tone in the thus generated composite image data is obtained.

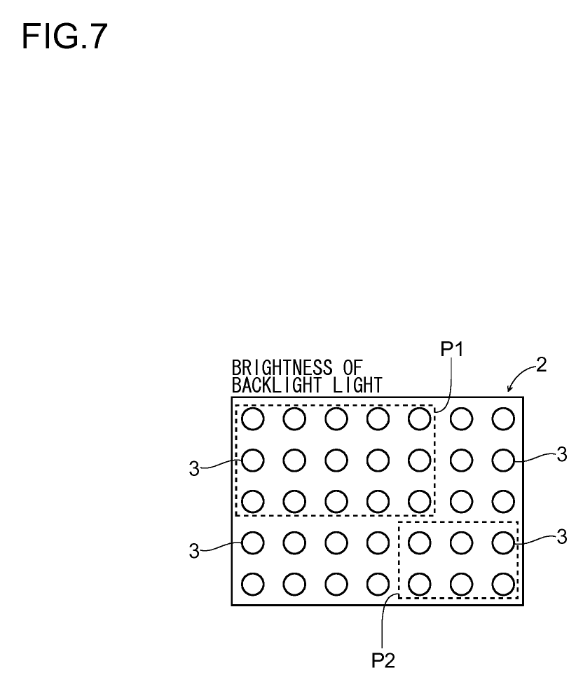

Also, in generating backlight data, it is set that all the light sources 3 emit light of the maximum brightness. That is, as shown in FIG. 7, instead of adjusting the brightness of the backlight light for each display area on a one-by-one basis, among the light sources 3, light sources 3 that cover the display area of image P1, light sources 3 that cover the display area of image P2, and light sources 3 that cover the other display areas are all set to emit light of the maximum brightness.

With this method, although the brightness of the backlight light is not adjusted for each display area on a one-by-one basis, the display area of image P1 of high importance (high required brightness) is made brighter than the display area of image P2 of low importance (low required brightness).

However, in comparison between the first method shown in FIGS. 4 and 5 and the second method shown in FIGS. 6 and 7, although the same image is actually displayed on the display surface of the liquid crystal display panel 1 with either of the two methods, but power consumption of the backlight unit 2 differs depending on which of the two methods is used.

Specifically, assuming that the power consumption when the light sources 3 are driven at the maximum brightness is “1”, the power consumption when the light sources 3 are driven at intermediate brightness is “0.5”, and the power consumption when the light sources 3 are driven at minimum brightness is “0.1”, and furthermore, that the number of the light sources 3 that cover the display area of image P1 is “15”, the number of the light sources 3 that cover the display area of image P2 is “6”, and the number of the light sources 3 that cover the other display areas is “14”, power consumption P of the backlight unit 2 when the first method (the one shown in FIGS. 4 and 5) is adopted is as follows: P=19.4 (=1×15+0.5×6+0.1×14).

On the other hand, when the second method (the one shown in FIGS. 6 and 7) is adopted, the power consumption P of the backlight unit 2 is as follows: P=35 (=1×35).

Thus, with the liquid crystal display device to which the present invention is applied, it is possible to make the display area of image P1 of high importance (high required brightness) brighter than the display area of image P2 of low importance (low required brightness) with reduced power consumption.

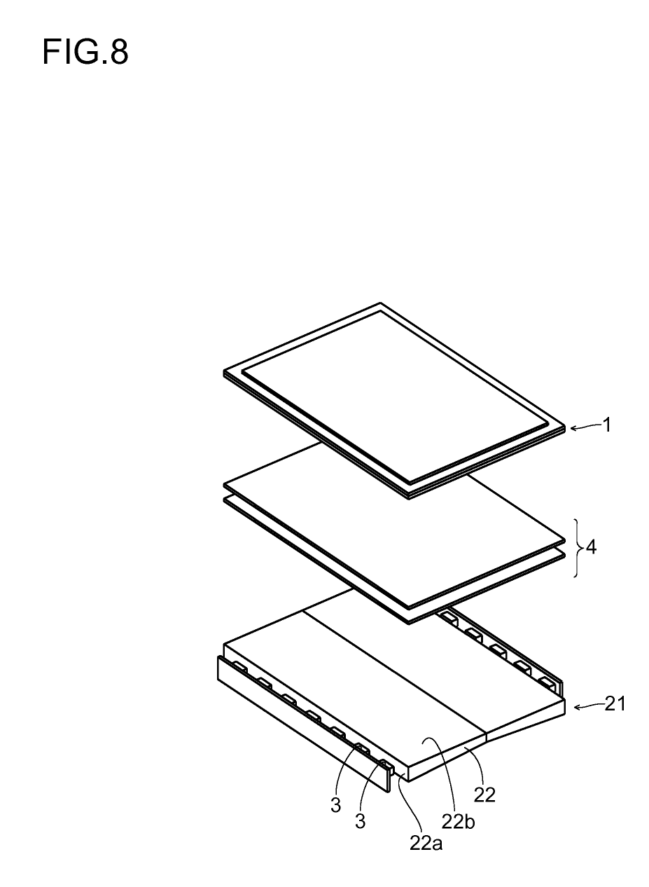

The above description has dealt with a case where the backlight unit 2 incorporated in the liquid crystal display device is a direct backlight unit, but instead, the present invention may be applied to a backlight unit 21 as shown in FIG. 8.

The backlight unit 21 shown in FIG. 8 is of a type that is referred to as, for example, an edge-light backlight, where a light guide plate 22 is disposed in a region directly under a liquid crystal display panel 1; a predetermined side end surface 22a of the light guide plate 22 serves as a light entrance surface (light sources 3 are disposed facing the light entrance surface) and a top surface 22b of the light guide plate 22 serves as a light exit surface (a surface facing the liquid crystal display panel 1). In the backlight unit 21, the light sources 3 may be disposed such that all surfaces of the light guide plate 22 each face at least one light source 3, or such that only one surface of the light guide plate 22 faces all the light sources 3.

In a case where the present invention is applied to a liquid crystal display device incorporating the backlight unit 21 as shown in FIG. 8, among the light sources 3, light sources 3 that are located in the vicinity of the display area of image P1 of high importance (high required brightness) are made to emit light of higher brightness than light sources 3 that are located in the vicinity of the display area of image P2 of low importance (low required brightness). As a result, in the top surface 22b of the light guide plate 22, brightness in a region that covers the display area of image P1 of high importance (high required brightness) is higher than brightness in a region that covers the display area of image P2 of low importance (low required brightness).

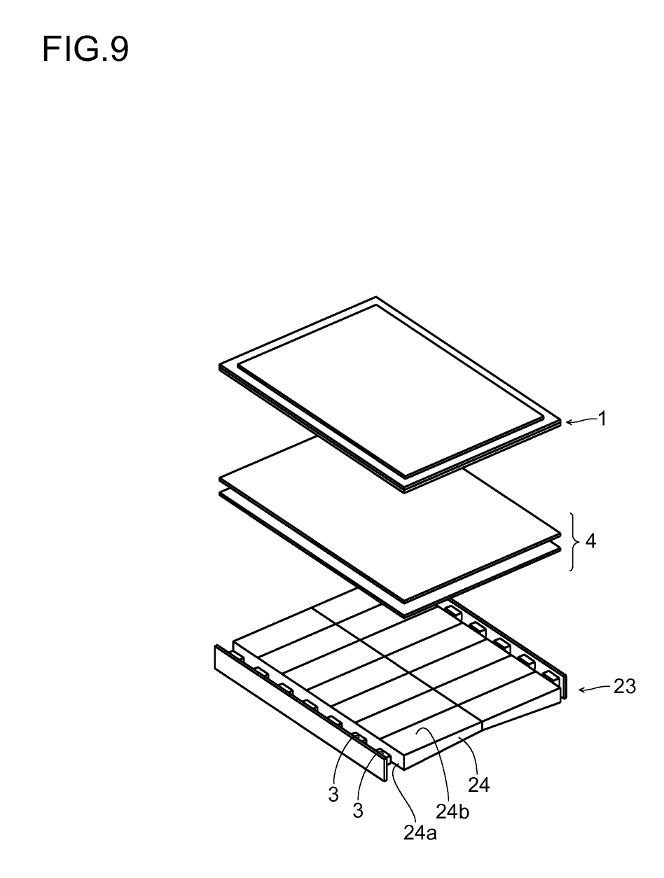

Furthermore, the present invention may be applied to a liquid crystal display device incorporating a backlight unit 23 as shown in FIG. 9. The backlight unit 23 is configured such that a plurality of small light guide plates 24 are arranged in a region directly under the liquid crystal display panel 1. A predetermined side end surface 24a of each of the light guide plates 24 serves as a light entrance surface, and a top surface 24b of each of the light guide plates 24 serves as a light exit surface.

Furthermore, although the above description deals with a case where the importance (the required brightness) of images P1 and P2 is judged based on the importance information (the required brightness information) of images P1 and P2, the importance (the required brightness) of the imaged P1 and P2 may be judged based on the display area information of images P1 and P2. For example, of images P1 and P2, one the display area of which is larger than the display area of the other may be judged to be the image of the highest importance. In this case, it is not necessary to bother to input the importance information (the required brightness information) of images P1 and P2. That is, it is possible to control based only on the display area information of images P1 and P2 such that the display area of image P1 of high importance (high required brightness) is brighter than the display area of image P2 of low importance (low required brightness).

Moreover, LEDs (light emitting diodes) may be used as the light sources 3, of which no detailed description has been given above concerning the configuration thereof. A detailed description will be given below of a case where LEDs are used as the light sources 3.

In addition, the liquid crystal data may be corrected, in contrast to the above-described example where the liquid crystal data is not corrected. This will also be described in detail below, in the description of embodiments.

Descriptions will be given below of embodiments in which the concepts of the present invention are embodied.

### First Embodiment

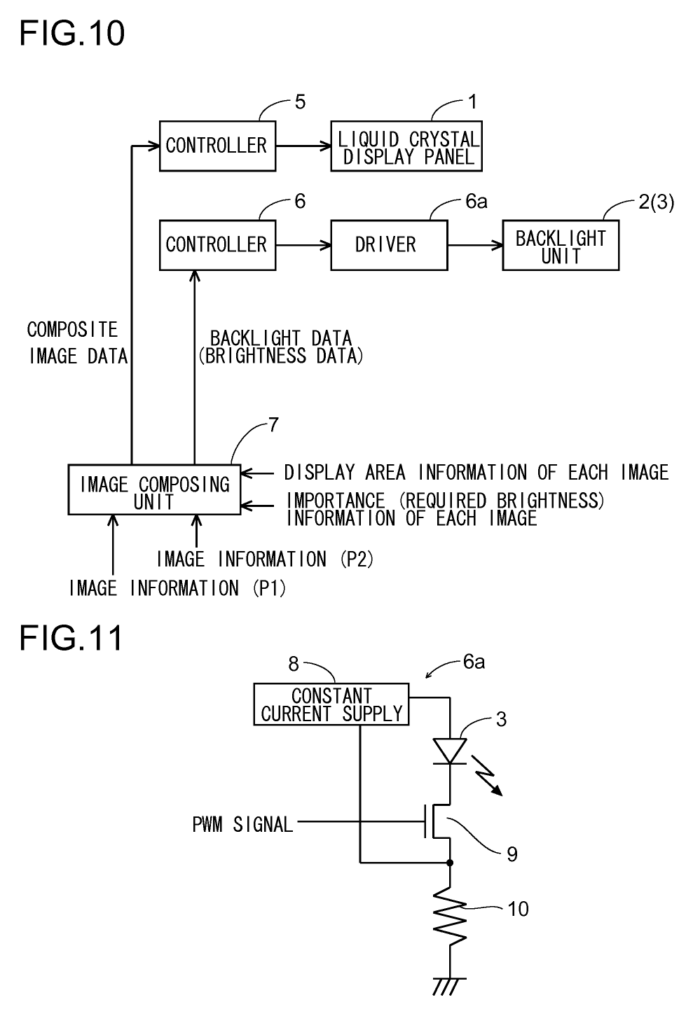

As illustrated in FIG. 10, according to a first embodiment of the present invention, a plurality of light sources 3 of a backlight unit 2 are each an LED 3. The LED 3 is driven by a driver 6a included in a controller 6.

The driver 6a has a circuit configuration shown in FIG. 11. Specifically, a constant current is supplied from a constant current supply 8 to the LED 3, a PWM signal is turned to High level to thereby turn on an FET (Field-Effect-Transistor) 9, and thereby the LED 3 is turned on. Further, the PWM signal is turned to Low level to thereby turn off the FET, and thereby the LED 3 is turned off. Incidentally, in FIG. 11, the circuit component denoted with a sign “10” is a resistor.

In the case of driving the LED 3 by using the driver 6a, brightness of light emitted from the LED 3 is changed by changing a value of a current supplied from the constant current supply 8. The brightness of light emitted from the LED 3 is also changed by changing a duty ratio of the PWM signal. The duty ratio of the PWM signal is defined as high period/(light period+low period).

Here, according to the first embodiment, an on/off ratio (the duty ratio of the PWM signal) of each of a plurality of LEDs 3 is able to be controlled individually. And, by individually controlling the on/off ratio of each of the plurality of LEDs 3, the brightness of the backlight light is made higher in the display area of image P1 of high importance (high required brightness) than in the display area of image P2 of low importance (low required brightness). That is, the LEDs 3 that cover the display area of image P1 of high importance (high required brightness) each emit light of higher brightness than the LEDs 3 that cover the display area of image P2 of low importance (low required brightness).

The PWM signal that controls the turning on/off of each of the plurality of LEDs 3 is generated by the controller 6 based on backlight data (brightness data) that the image composing unit 7 outputs.

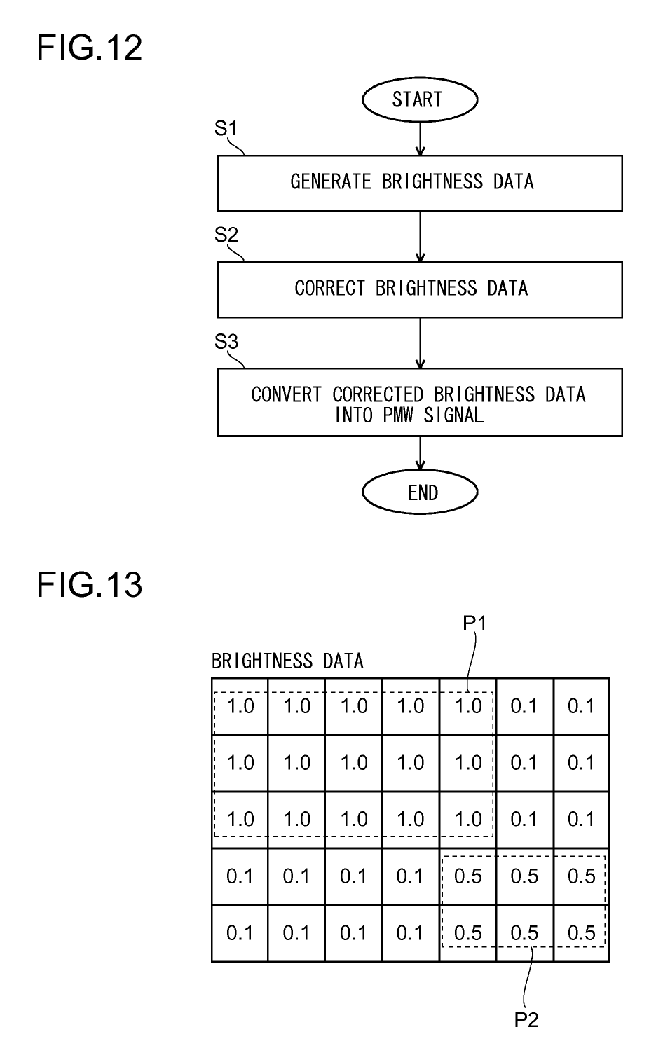

In a case where a composite image as shown in FIG. 3 is displayed on a display surface of a liquid crystal display panel 1, the display operation is carried out according to the following flow (see the flow chart of FIG. 12). First, in step S1, the image composing unit 7 generates brightness data as shown in FIG. 13. The brightness data generated here corresponds to the importance (required brightness) of images P1 and P2, and the brightness data is set such that the brightness of the backlight light is higher in the display area of image P1 than in the display area of image P2. That is, the brightness of light emitted from each of the LEDs 3 that cover the display area of image P1 is set at a maximum value (“1”) and the brightness of light emitted from each of the LEDs 3 that cover the display area of image P2 is set at a value (“0.5”) that is lower than the maximum value. The brightness of light emitted from each of the LEDs 3 that cover the other areas is set at a minimum value (“0.1”).

Thereafter, in step S2, multiplication is performed between the brightness data and an LED correction value, to thereby correct the brightness data. Here, the LED correction value is a value for cancelling inter-individual variation among the LEDs 3 and temperature characteristics of the LEDs 3.

Next, in step S3, the resulting corrected brightness data is converted into PWM signals.

The LEDs 3 receive the PWM signals to be driven accordingly, and as a result, the backlight light has different brightness in the display areas of images P1 and P2 based on the importance (the required brightness) of images P1 and P2.

In the first embodiment, with the above configuration, it is possible to make the display area of image P1 of the high importance (high required brightness) brighter than the display area of image P2 of low importance (low required brightness and to reduce the power consumption of the backlight unit 2 at the same time. Furthermore, it is also possible to minutely adjust the brightness of the backlight light for each display area on a one-by-one basis.

### Second Embodiment

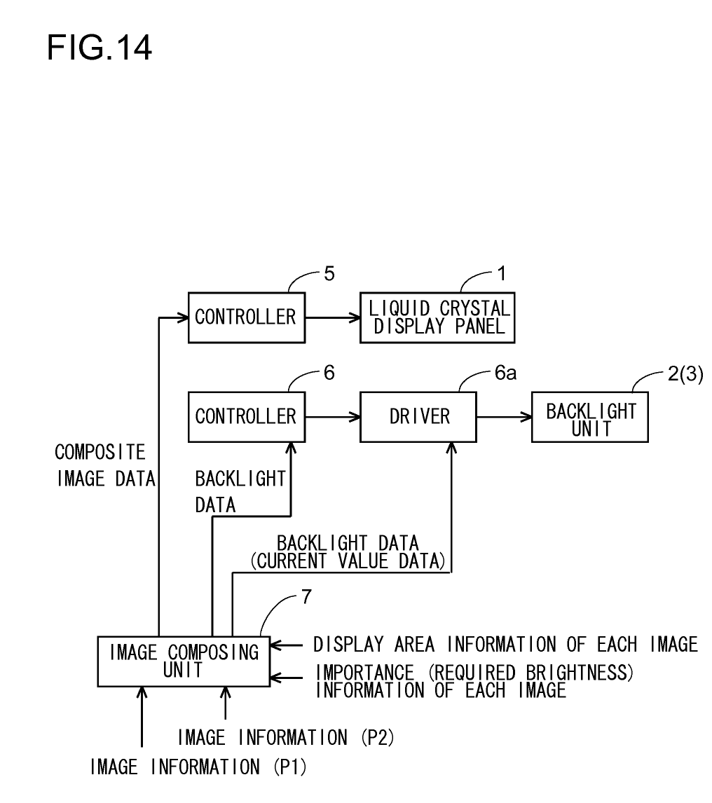

As illustrated in FIG. 14, in a second embodiment, like in the first embodiment, a plurality of light sources 3 of a backlight unit 2 are each an LED 3. Furthermore, the LED 3 is controlled by a driver 6a included in a controller 6. The driver 6a has a circuit configuration similar to the circuit configuration shown in FIG. 11.

Here, in the second embodiment, in contrast to the first embodiment, it is possible to individually control the value of a current supplied to each of a plurality of LEDs 3. And, by individually controlling the value of the current supplied to each of the plurality of LEDs 3, the brightness of the backlight light is made higher in the display area of image P1 of high importance (high required brightness) than in the display area of image P2 of low importance (low required brightness). That is, the LEDs 3 that cover the display area of image P1 of high importance (high required brightness) emit brighter light than the LEDs 3 that cover the display area of image P2 of low importance (low required brightness).

The value of the current supplied to each of the plurality of LEDs 3 is generated based on backlight data (current value data) that the image composing unit 7 outputs.

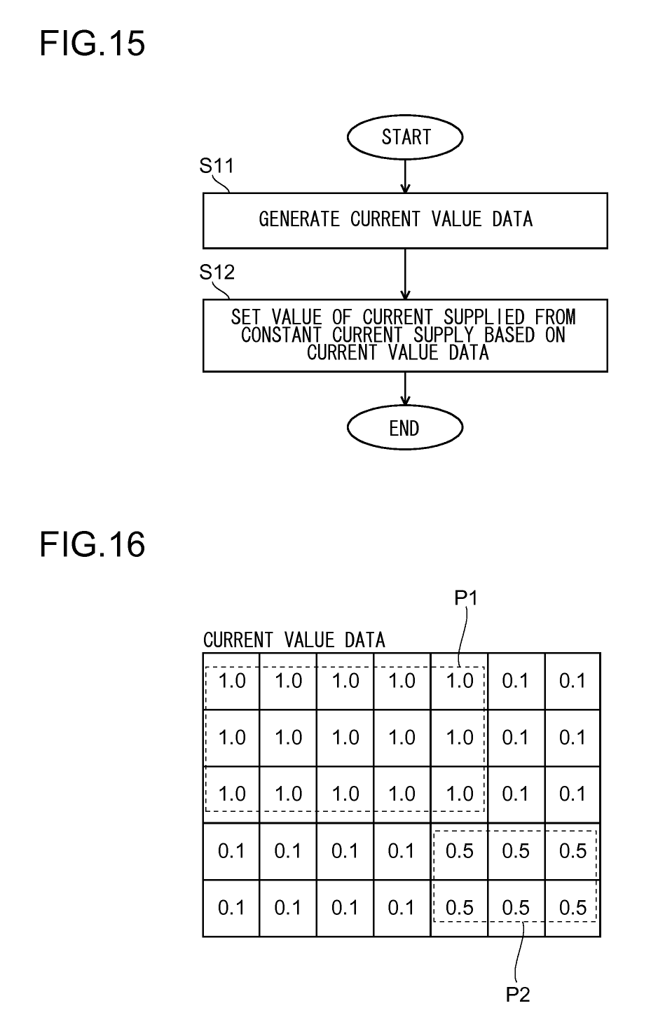

In a case where a composite image as shown in FIG. 3 is displayed on a display surface of a liquid crystal display panel 1, the display operation is carried out according to the following flow (see the flow chart of FIG. 15). First, in step S11, the image composing unit 7 generates current value data as shown in FIG. 16. The current value data generated here corresponds to the importance (required brightness) of images P1 and P2, and the current value data is set such that the brightness of the backlight light is higher in the display area of image P1 than in the display area of image P2. That is, the value of the current supplied to each of the LEDs 3 that cover the display area of image P1 is set at a maximum value (“1”) and the value of the current supplied to each of the LEDs 3 that cover the display area of image P2 is set at a value (“0.5”) lower than the maximum value. The value of the current supplied to each of the LEDs 3 that cover the other areas is set at a minimum value (“0.1”).

Next, in step S12, values of currents supplied from a constant current supply 8 (see FIG. 11) are set based on the current value data.

The LEDs 3 are each driven by a current of the thus set value received from the constant current supply 8, whereby brightness of the backlight light is made different between in the display area of image P1 and in the display area of image P2 based on the importance (required brightness) of images P1 and P2.

Here, it should be noted that, although the PWM signal is generated based on an LED correction value, it does not correspond to the importance (required brightness) of images P1 and P2. Thus, the PWM signal may be generated by using a conventional method without any modification.

In the second embodiment, with the above configuration, it is possible to make the display area of the image P2 of the high importance (high required brightness) brighter than the display area of image P2 of low importance (low required brightness) and simultaneously reduce the power consumption of the backlight unit 2. Furthermore, the controller 6 may be a conventional one, and there is no need of taking the importance (required brightness) of images P1 and P2 into consideration to generate backlight data which is inputted to the controller 6.

### Third Embodiment

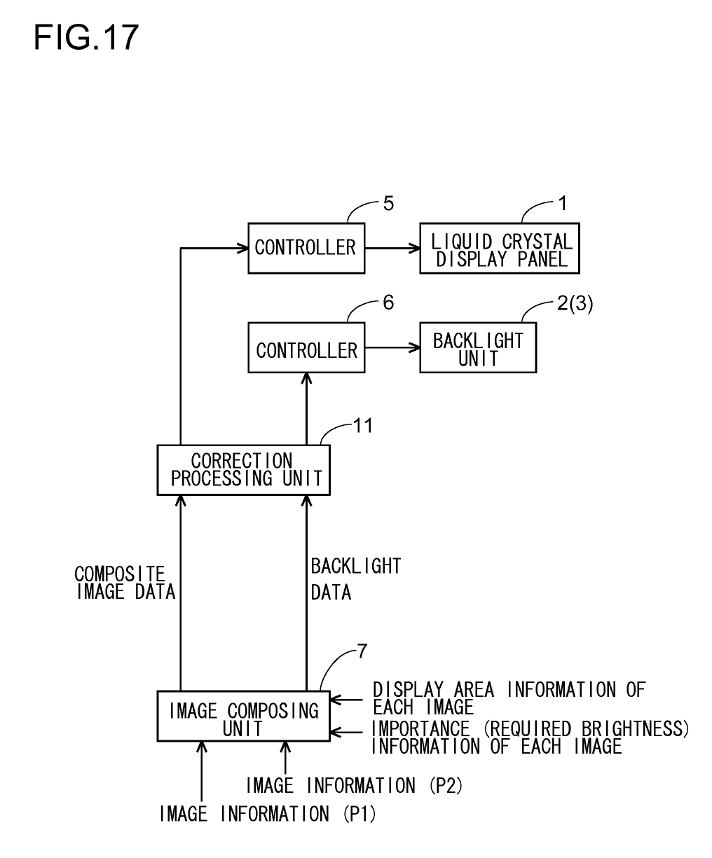

As illustrated in FIG. 17, in a third embodiment, there is further provided a correction processing unit 11 which corrects liquid crystal data (light transmittance of each pixel). Here, the correction processing unit 11 is provided for reducing unevenness in brightness occurring when the brightness of the backlight light is partly changed.

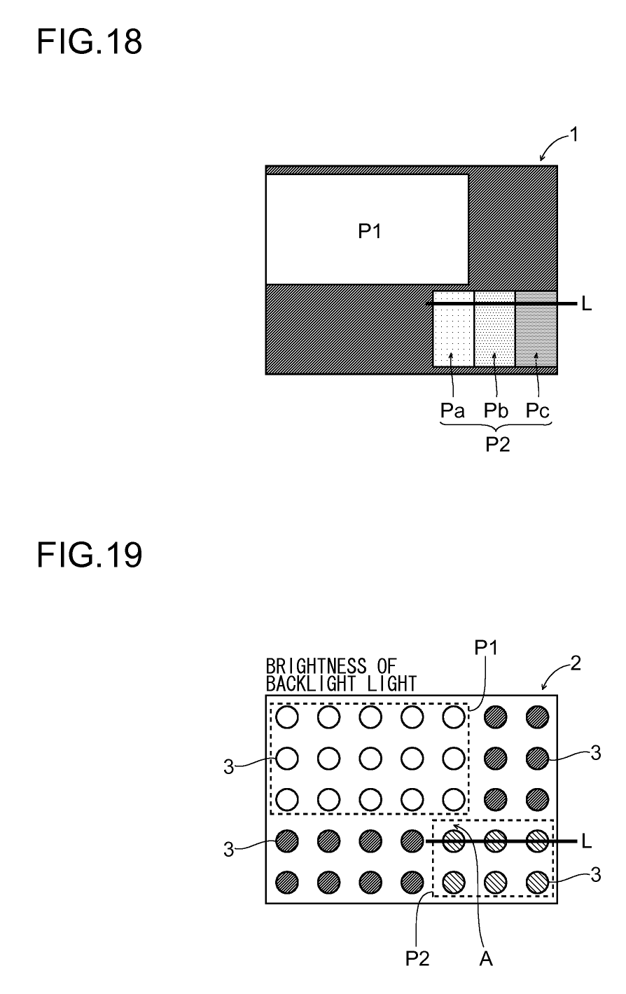

Now, a description will be given of the unevenness in brightness that occurs when the brightness of the backlight light is partly changed. For example, in a case where a composite image as shown in FIG. 18 is displayed on the display surface of the liquid crystal display panel 1, according to the present invention, as shown in FIG. 19, among the light sources 3, light sources 3 that cover the display area of image P1 are made to emit light of maximum brightness and light sources 3 that cover the display area of image P2 are made to emit light of brightness that is lower than the maximum brightness. Furthermore, among the light sources 3, light sources 3 that cover display areas other than the display areas of images P1 and P2 are made to emit light of minimum brightness. In this way, the brightness of the backlight light is adjusted for each display area on a one-by-one basis. Thus, by adjusting the brightness of the backlight light for each display area on a one-by-one basis, the display area of image P1 of high importance (high required brightness) is made brighter than the display area of image P2 of low importance (low required brightness).

However, even through the brightness of the backlight light is adjusted for each display area on a one-by-one basis, in a given area A in the display area of image P2, the given area A happening to be located close to a light source 3 that emits light of the maximum brightness, the brightness of the backlight light is much higher than is expected. In other words, actually displayed image P2 includes a too bright part.

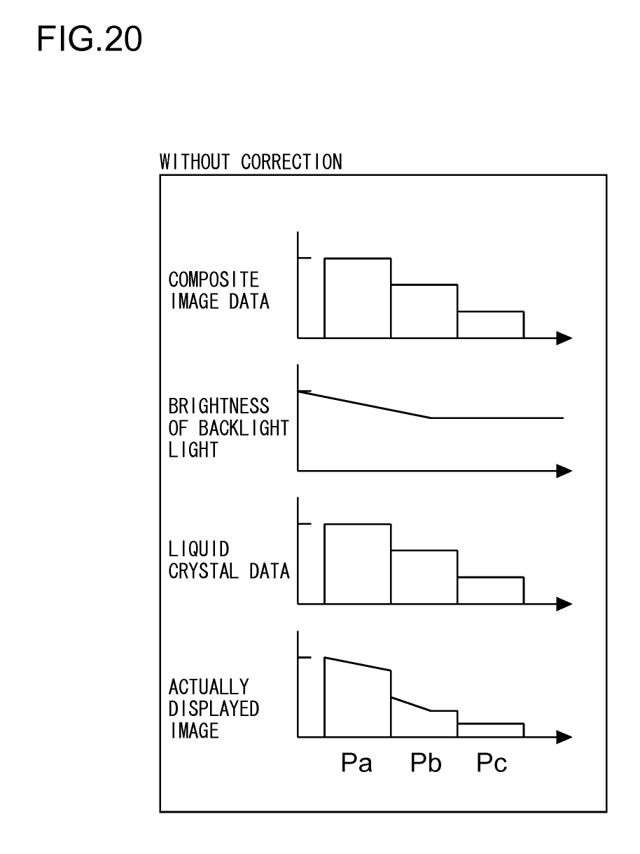

More specifically, how an image is actually displayed depends on values obtained by multiplying the liquid crystal data (light transmittance of each pixel) by the brightness of the backlight light (=liquid crystal data×brightness of backlight light). Thus, as shown in FIG. 20, with respect to the area along line L in FIGS. 18 and 19, if the liquid crystal data is generated directly reflecting the tone that is set in the composite image data, the above-described backlight light of the too high brightness results in difference between the tone of the actually displayed image and the tone set in the composite image data, which results in visible unevenness in brightness.

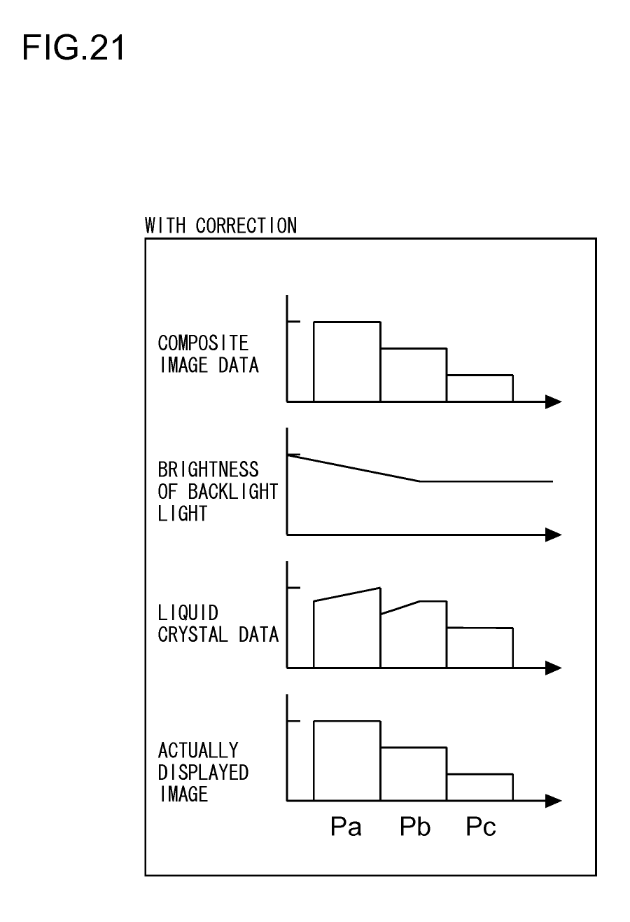

Thus, in the third embodiment, in order to reduce the occurrence of such unevenness in brightness, the liquid crystal data includes values obtained by dividing the composite image data by the brightness of the backlight light (=composite image data/brightness of the backlight light). As a result, as shown in FIG. 21, the composite image data is correctly reproduced in the actually displayed image.

Here, assuming that the range of the values in the liquid crystal data is from 0 to 255, and that the range of the values of the brightness of the backlight light is from 0 to 1.0, if the brightness of the backlight light is lowered to 50%, the values in the liquid crystal data are obtained by dividing the values in the composite image data by 0.5 (=composite image data/0.5), but any of the thus obtained values that is larger than 255 is rounded to 255. That is, in this case, if a value in the composite image data is larger than 127, the corresponding value in the liquid crystal data is 255, and this invites tone difference in an actually displayed image.

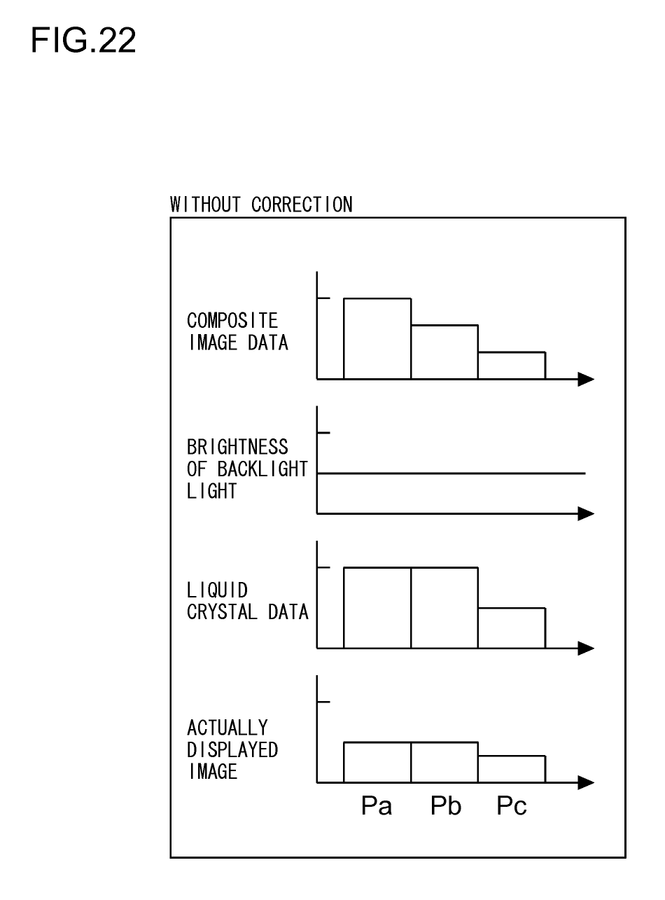

That is, as shown in FIG. 22, if values in the composite image data corresponding to regions Pa and Pb are larger than 127, values in the liquid crystal data corresponding to the regions Pa and Pb are 255, and as a result, the actually displayed image is not a correct reproduction of the composite image data.

Such an inconvenience can be dealt with by a modified example of the third embodiment where correction as described below is able to be performed.

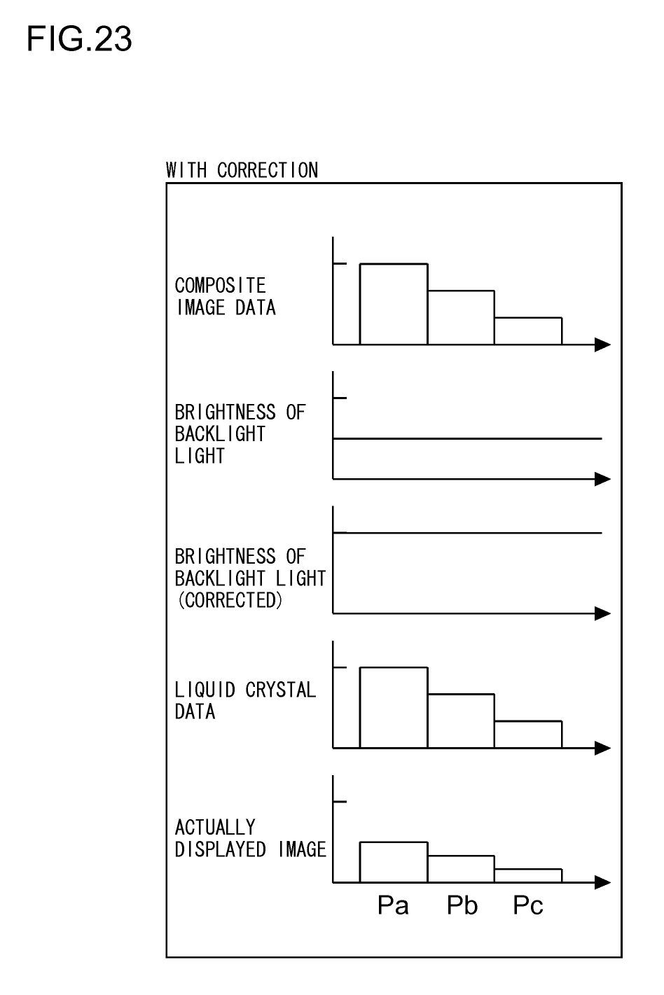

That is, in a case where the brightness of the backlight light in the display area of image P1 is 100% and the brightness of the backlight light in the display area of image P2 is 50%, the liquid crystal data is obtained with the brightness of the backlight light in the display area of image P1 remaining as it is and the brightness of the backlight light in the display area of image P2 doubled. Thus, the liquid crystal data for image P1 is obtained by “composite image data/(1.0×1.0)” and the liquid crystal data for image P2 is obtained by “composite image data/(0.5×2.0).” As a result, the actually displayed image is, as shown in FIG. 23, a correct reproduction of the composite image data, although the actually displayed image generally appears dark.

Incidentally, in a case where the brightness of the backlight light in a given area A (see FIG. 19) in the display area of image P2 is 80%, the liquid crystal data for the given area A is obtained by “composite image data/(0.8×2.0),” that is, “composite image data/1.6.” In this way, the light transmittance of each pixel in the given area A is lowered, and thereby, the initial object is achieved.

Another possible modified example is one where correction as described below is able to be performed.

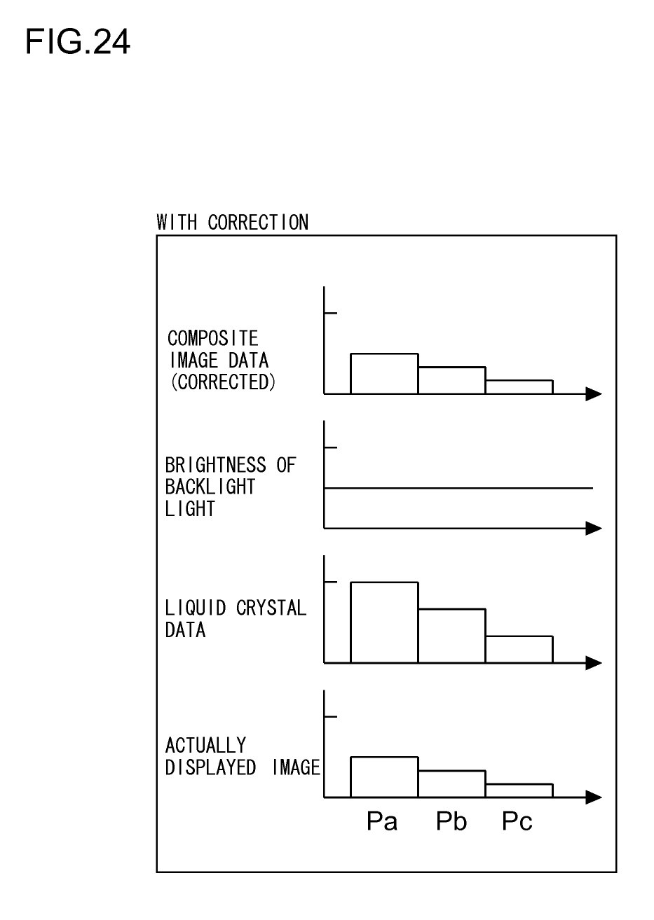

That is, in the case where the brightness of the backlight light in the display area of image P1 is 100% and the brightness of the backlight light in the display area of image P2 is 50%, the liquid crystal data is obtained with the brightness of the backlight light in the display area of image P1 remaining as it is and the brightness of the backlight light in the display area of image P2 reduced to 50%. That is, weights are assigned to the composite image data according to the brightness of the backlight light. Thus, the liquid crystal data for image P1 is obtained by “composite image data×1.0/1.0” and the liquid crystal data for image P2 is obtained by “composite image data×0.5/0.5.” As a result, the actually displayed image is, as shown in FIG. 24, a correct reproduction of the composite image data, although the actually displayed image generally appears dark.

Incidentally, in a case where the brightness of the backlight light in the given area A (see FIG. 19) in the display area of image P2 is 80%, the liquid crystal data for the given area A is obtained by “composite image data×0.5/0.8,” that is, “composite image data/1.6.” In this way, the light transmittance of each pixel in the given area A is lowered, and thereby, the initial object is achieved.

According to the third embodiment and according to the modified examples thereof, it is possible to reduce unevenness in brightness by performing the above described corrections. It is also possible to reduce a phenomenon in which tone difference becomes invisible in a bright region in the display area of image P2.

The embodiments disclosed herein are to be considered in all respects as illustrative and not restrictive. The scope of the present invention is set out in the appended claims and not in the description of the embodiments hereinabove, and includes any variations and modifications within the sense and scope equivalent to those of the claims.

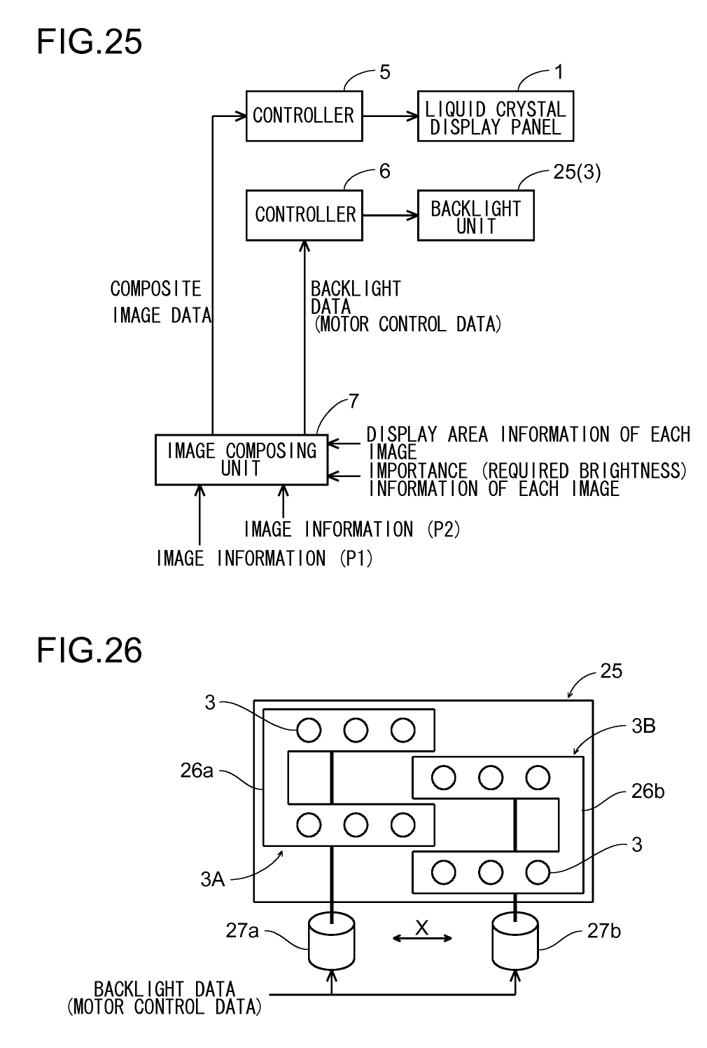

For example, in the above embodiments, a plurality of light sources are individually adjusted in brightness of light they emit, to thereby make brightness of backlight light partially different, but this is not meant as a limitation, and a backlight unit 25 as shown in FIGS. 25 and 26 may be provided.

Specifically, a plurality of light sources 3 are divided into two groups, namely, group 3A and group 3B, the light sources 3 of group 3A are mounted on a U-shaped substrate 26a and the light sources 3 of group 3B are mounted on a U-shaped substrate 26b. The substrates 26a and 26b are arranged to engage with each other and connected to a motor 27a and a motor 27b, respectively, and thereby, the substrates 26a and 26b are movable in direction X (a horizontal direction). That is, the two groups 3A and 3B of light sources are each movable in direction X. The motors 27a and 27b are driven on receiving backlight data (motor control data), which is based on the importance (required brightness) information of images P1 and P2.

And, in this modified example, by moving at least one (including a case of both) of the two light source groups of groups 3A and 3B in direction X, the brightness of the backlight light is made higher in the display area of image P1 of high importance (high required brightness) than in the display area of image P2 of low importance (low required brightness), whereby the display area of image P1 of high importance (high required brightness) is made brighter than the display area of image P2 of low importance (low required brightness).

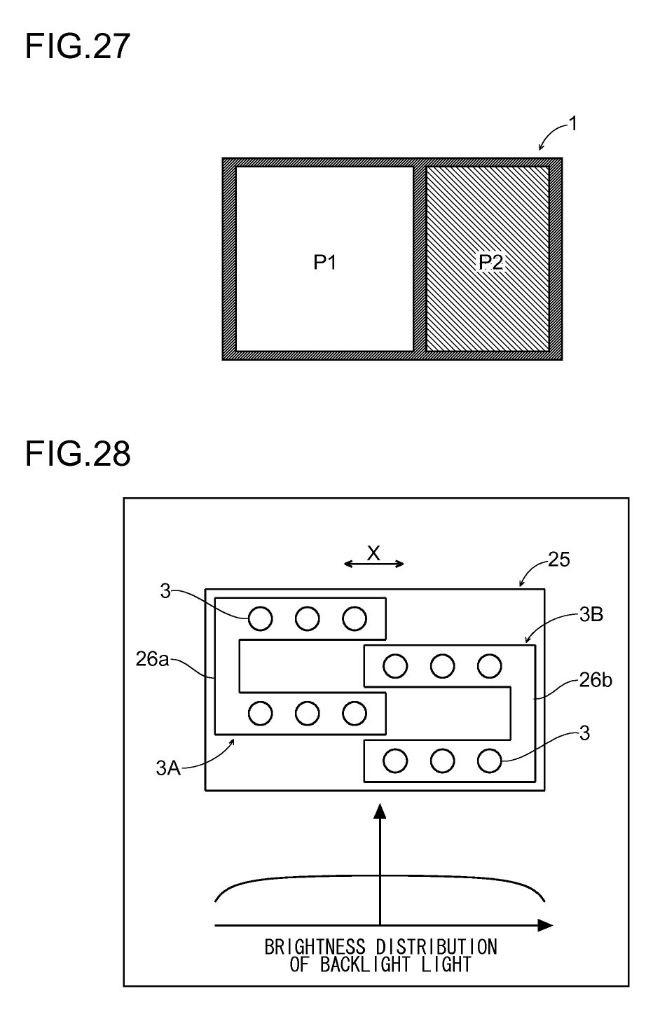

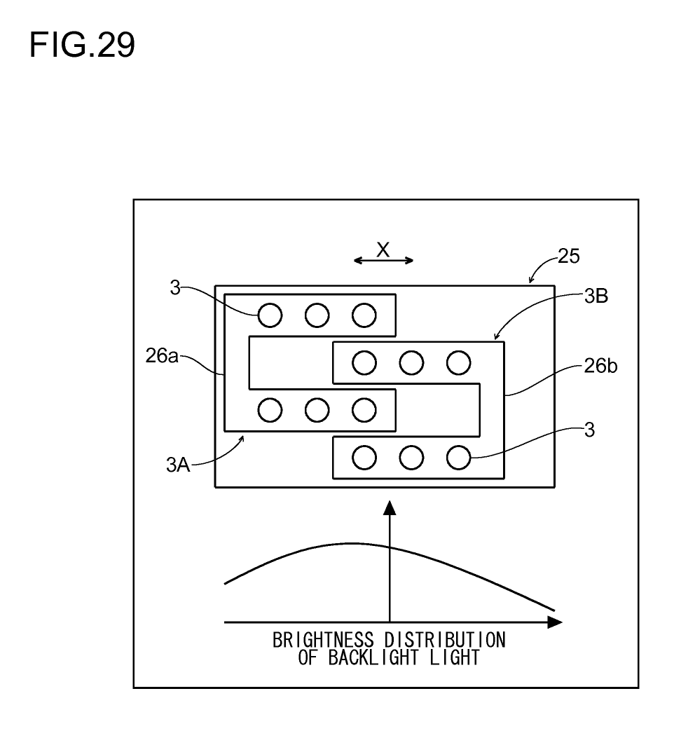

For example, in a case where a composite image as shown in FIG. 27 is displayed on the display surface of the liquid crystal display panel 1, if positions of the two groups of light sources, namely groups 3A and 3B, in direction X are as illustrated in FIG. 28, brightness distribution of the backlight light in direction X is substantially uniform. That is, the display area of image P1 of high importance (high required brightness) is not brighter than the display area of image P2 of low importance (low required brightness). Here, if the light source group 3B is moved in direction X from the state illustrated in FIG. 28 into the state illustrated in FIG. 29, the brightness of the backlight light is higher on an image-P1 side of the display area than on an image-P2 side, and as a result, the display area of image P1 of high importance (high required image) is made brighter than the display area of image P2 of low importance (low required brightness). Specifically, the maximum brightness in the state illustrated in FIG. 29 is on the order of twice as high as the maximum brightness in the state illustrated in FIG. 28.

In the above-described modified example, there are no specific limitations to the positions of the light sources 3, the number of the light sources 3, and a space between adjacent ones of the light sources 3, and these may be changed for the purpose of reducing unevenness in brightness. It is also possible to reduce occurrence of uneven brightness by adjusting the space between the liquid crystal display panel 1 and the backlight unit 2 or by using a diffusion plate.

Further, in the above-described modified example, the two light source groups 3A and 3B may each be movable in a vertical direction (a direction perpendicular to direction X).

### LIST OF REFERENCE SYMBOLS

1 liquid crystal display panel (display panel)

2, 21, 23, 25 backlight unit

3 light source (LED)

7 image composing unit

22, 24 light guide plate

1. A display device, comprising:
a display panel;
a backlight unit which has a light-emitting light source and illuminates the display panel; and
an image composing unit which generates composite image data for displaying a composite image composed of a plurality of images each displayed in a desired display area on the display panel and backlight data for adjusting brightness of backlight light outputted from the backlight unit,
wherein
the backlight data is generated according to importance of each of the plurality of images; and
a display area of an image of high importance among the plurality of images is made brighter than a display area of an image of low importance among the plurality of images by adjusting the brightness of the backlight light for each display area on a one-by-one basis based on the backlight data.

2. The display device according to claim 1,
wherein
an image of the plurality of images a display area of which is largest is judged to be an image of highest importance.

3. The display device according to claim 1,
wherein
the light source includes a plurality of light sources which are driven independently of one another; and
the brightness of the backlight light is adjusted for each display area on a one-by-one basis by adjusting brightness of light emitted from each of the plurality of light sources individually based on the backlight data.

4. The display device according to claim 3,
wherein
a plurality of light emitting diodes are used as the plurality of light sources; and
ratios of on-period to off-period of the plurality of light emitting diodes are individually controllable.

5. The display device according to claim 3,
wherein
a plurality of light emitting diodes are used as the plurality of light sources; and
values of currents supplied to the plurality of light emitting diodes are individually controllable.

6. The display device according to claim 1,
wherein
light transmittance of each of pixels of the display panel is calculated based on the composite image data and the brightness of the backlight light.

7. The display device according to claim 6,
wherein,
in calculating the light transmittance of each of the pixels of the display panel, the brightness of the backlight light is corrected based on a ratio between the brightness of the backlight light in the display area of the image of high importance and the brightness of the backlight light in the display area of the image of low importance.

8. The display device according to claim 6,
wherein,
in calculating the light transmittance of each of the pixels of the display panel, the composite image data is corrected based on a ratio between the brightness of the backlight light in the display area of the image of high importance and the brightness of the backlight light in the display area of the image of low importance.

9. The display device of claim 1, further comprising a light guide plate having a side end surface opposite to which the light source is disposed and a top surface from which light introduced into the light guide plate through the side end surface is outputted, the light guide plate being attached to the backlight unit, the light outputted from the top surface of the light guide plate being the backlight light,
wherein
brightness of light emitted from part of the light source that is located close to the display area of the image of high importance is higher than brightness of light emitted from part of the light source that is located close to the display area of the image of low importance, to thereby make brightness in a region of the top surface of the light guide plate covering the display area of the image of high importance higher than brightness in a region of the top surface of the light guide plate covering the display area of the image of low importance.

10. The display device according to claim 1,
wherein
the light source is divided into two or more groups of light sources; and the two or more groups of light sources are movably held.

11. A display method of a display device including a display panel, a backlight unit which has a light-emitting light source and illuminates the display panel, and an image composing unit which generates composite image data for displaying a composite image composed of a plurality of images each displayed in a desired display area on the display panel and backlight data for adjusting brightness of backlight light outputted from the backlight unit,
the display method comprising steps of:
generating the backlight data according to importance of each of the plurality of images; and
making a display area of an image of high importance among the plurality of images brighter than a display area of an image of low importance among the plurality of images by adjusting the brightness of the backlight light for each display area on a one-by-one basis based on the backlight data.
